(19) United States
(12) Patent Application Publication
(10) Pub. No.: US 2024/0256970 A1
(43) Pub. Date: Aug. 1, 2024

(54) RADIO NETWORK CONTROL

(71) Applicant: Nokia Technologies Oy, Espoo (FI)

(72) Inventors: Anna PANTELIDOU, Massy (FR); Hakon HELMERS, Massy (FR); Cinzia SARTORI, Munich (DE); Malgorzata TOMALA, Wroclaw (PL)

(21) Appl. No.: 18/558,996

(22) PCT Filed: May 3, 2022
(86) PCT No.: PCT/FI2022/050290

§ 371 Date: Nov. 3, 2023

(30) Foreign Application Priority Data
May 4, 2021 (FI) 20215516

(51) Int. Cl. G06N 20/00; H04L 41/16; H04W 24/02

(52) U.S. Cl. CPC G06N 20/00; H04L 41/16; H04W 24/02

(57) ABSTRACT

As an aspect, there is provided an apparatus, caused at least to: process, by a central network unit, information on aspects of a machine learning algorithm to be used in an ununiform and/or distributed-manner operating radio communication network, wherein the aspects are characterizing to usage of the machine learning algorithm; examine information on access units in the radio communication network, wherein the information is associated with the location and/or capabilities of the access units; select at least one access unit among the access units to which the machine learning algorithm is to be delivered or from which the machine learning algorithm is to be requested based on the aspects of the machine learning algorithm and on the information on the access units for the machine learning algorithm being used in the ununiform and/or distributed-manner operating radio communication network in a centrally controlled manner.

### FIELD

The invention relates to communications.

### BACKGROUND

The following description of background art may include insights, discoveries, understandings or disclosures, or associations together with disclosures not known to the relevant art prior to the present invention but provided by the invention. Some such contributions of the invention may be specifically pointed out below, whereas other such contributions of the invention will be apparent from their context.

In 5G radio access networks, base station functionality may be divided into two entities: a distributed unit (DU) that is typically responsible for radio link control (RLC), medium access control (MAC) and physical layer (PHY) operations and a centralized unit (CU) that is typically responsible for radio resource control (RRC) and packet data convergence protocol (PDCP) operations. The responsibility of physical layer operations may be split with a radio head or radio unit (RU), that might be a separate unit from the DU.

The key concept of Open RAN is “opening” the protocols and interfaces between these various building blocks (radios, hardware and software) in the RAN. Some of the interfaces are fronthaul between the RU and the DU, midhaul between the DU and CU and backhaul connecting the RAN to the core. The DU and CU may be implemented as computers running software. Instead of using custom hardware, they can be virtualized and run on any (cloud) server as software platforms based on general purpose processors.

The split architecture enables a 5G network to utilize different distribution of tasks between CU and DUs depending on midhaul availability, network design and computing power, for instance. CU functionalities may be embedded with the DU on the same server, or it can be pushed up the network as a virtualized aggregation entity, along with an OpenRAN Controller or aggregator. In general, design factors for CU, DU and RU task split include the need to support specific quality of service (QOS) per offered services (e.g. low latency, high throughput for urban areas) and real/non-real time applications, support of specific user density and load demand per given geographical area as well as available transport networks with different performance levels. The future evolution of RAN will be toward dynamic functional splits.

### BRIEF DESCRIPTION

According to an aspect, there is provided an apparatus comprising: at least one processor and at least one memory including a computer program code, the at least one memory and the computer program code configured to, with the at least one processor, cause the apparatus at least to: process, by a central network unit, information on aspects of a machine learning algorithm to be used in an ununiform and/or distributed-manner operating radio communication network, wherein the aspects are characterizing to usage of the machine learning algorithm; examine information on access units in the radio communication network, wherein the information is associated with the location and/or capabilities of the access units; select at least one access unit among the access units to which the machine learning algorithm is to be delivered or from which the machine learning algorithm is to be requested based on the aspects of the machine learning algorithm and on the information on the access units for the machine learning algorithm being used in the ununiform and/or distributed-manner operating radio communication network in a centrally controlled manner, and transmit the machine learning algorithm and/or the information on aspects of a machine learning algorithm to the selected at least one access unit or request the machine learning algorithm from the selected at least one access unit.

According to an aspect, there is provided a method comprising: processing, by a central network unit, information on aspects of a machine learning algorithm to be used in an ununiform and/or distributed-manner operating radio communication network, wherein the aspects are characterizing to usage of the machine learning algorithm; examining information on access units in the radio communication network, wherein the information is associated with the location and/or capabilities of the access units; selecting at least one access unit among the access units to which the machine learning algorithm is to be delivered or from which the machine learning algorithm is to be requested based on the aspects of the machine learning algorithm and on the information on the access units for the machine learning algorithm being used in the ununiform and/or distributed-manner operating radio communication network in a centrally controlled manner, and transmitting the machine learning algorithm and/or the information on aspects of a machine learning algorithm to the selected at least one access unit or request the machine learning algorithm from the selected at least one access unit.

According to an aspect, there is provided an apparatus comprising means for processing, by a central network unit, information on aspects of a machine learning algorithm to be used in an ununiform and/or distributed-manner operating radio communication network, wherein the aspects are characterizing to usage of the machine learning algorithm; means for examining information on access units in the radio communication network, wherein the information is associated with the location and/or capabilities of the access units; means for selecting at least one access unit among the access units to which the machine learning algorithm is to be delivered or from which the machine learning algorithm is to be requested based on the aspects of the machine learning algorithm and on the information on the access units for the machine learning algorithm being used in the ununiform and/or distributed-manner operating radio communication network in a centrally controlled manner, and means for transmitting the machine learning algorithm and/or the information on aspects of a machine learning algorithm to the selected at least one access unit or request the machine learning algorithm from the selected at least one access unit.

According to an aspect, there is provided a computer program product for a computer, comprising software code portions for processing, by a central network unit, information on aspects of a machine learning algorithm to be used in an ununiform and/or distributed-manner operating radio communication network, wherein the aspects are characterizing to usage of the machine learning algorithm; examining information on access units in the radio communication network, wherein the information is associated with the location and/or capabilities of the access units; selecting at least one access unit among the access units to which the machine learning algorithm is to be delivered or from which the machine learning algorithm is to be requested based on the aspects of the machine learning algorithm and on the information on the access units for the machine learning algorithm being used in the ununiform and/or distributed-manner operating radio communication network in a centrally controlled manner, and transmitting the machine learning algorithm and/or the information on aspects of a machine learning algorithm to the selected at least one access unit or request the machine learning algorithm from the selected at least one access unit.

### LIST OF DRAWINGS

Some embodiments of the present invention are described below, by way of example only, with reference to the accompanying drawings, in which

FIG. 1 illustrates an example of a system;

FIG. 2 is a flow chart, and

FIG. 3 illustrates an example of apparatuses.

### DESCRIPTION OF SOME EMBODIMENTS

In the following, different exemplifying embodiments will be described using, as an example of an access architecture to which the embodiments may be applied, a radio access architecture based on long term evolution advanced (LTE Advanced, LTE-A) or new radio (NR, 5G), without restricting the embodiments to such an architecture, however. It is obvious for a person skilled in the art that the embodiments may also be applied to other kinds of communications networks having suitable means by adjusting parameters and procedures appropriately. Some examples of other options for suitable systems are the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

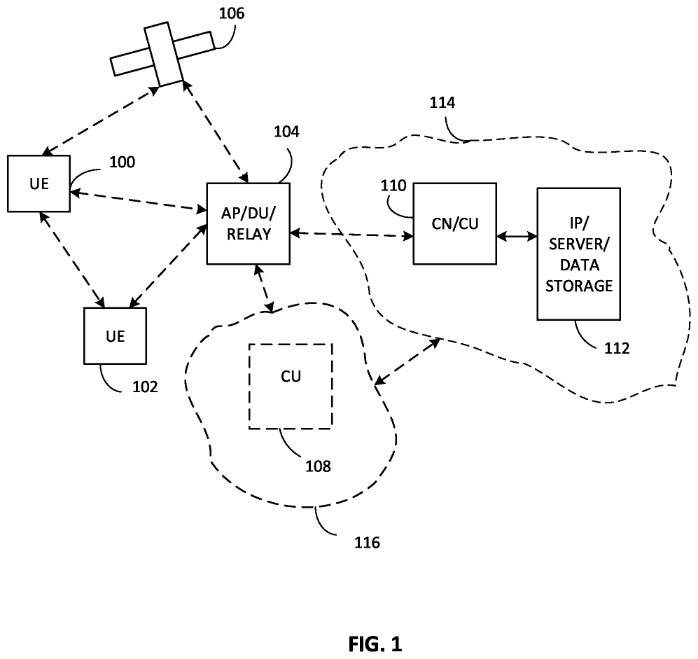

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system given as an example but a person skilled in the art may apply the solution to other communication systems provided with necessary properties.

The example of FIG. 1 shows a part of an exemplifying radio access network.

FIG. 1 shows user devices 100 and 102 configured to be in a wireless connection on one or more communication channels in a cell with an access node or access point (such as (e/g)NodeB) 104 providing the cell. The physical link from a user device to a (e/g)NodeB is called uplink or reverse link and the physical link from the (e/g)NodeB to the user device is called downlink or forward link. It should be appreciated that (e/g)NodeBs or their functionalities may be implemented by using any node, host, server or access point etc. entities suitable for such a usage, for example according to a higher layer split architecture, comprising a central-unit (so-called gNB-CU) controlling one or more distributed units (so-called gNB-DU).

A communications system typically comprises more than one (e/g)NodeB in which case the (e/g)NodeBs may also be configured to communicate with one another over links, wired or wireless, designed for the purpose. These links may be used for signalling purposes. The (e/g)NodeB is a computing device configured to control the radio resources of communication system it is coupled to. The NodeB may also be referred to as a base station, an access point or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to user devices. The antenna unit may comprise a plurality of antennas or antenna elements. The (e/g)NodeB is further connected to core network 110 (CN or next generation core NGC). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc.

The user device (also called UE, user equipment, user terminal, terminal device, etc.) illustrates one type of an apparatus to which resources on the air interface are allocated and assigned, and thus any feature described herein with a user device may be implemented with a corresponding apparatus, also including a relay node. Network shown in FIG. 1, may support relay operation, both in-band and out-band relaying. In-band relaying may be supported by an integrated access and backhaul (IAB) node and access node (gNB) operations may be carried out by a distributed unit (DU) of the IAB node. The UE operations may be carried out by mobile termination (MT) part of the IAB node. Relaying may be applied to backhauling e.g. when optical or dedicated wireless backhaul is unavailable or inconvenient. New radio integrated access and backhaul (NR IAB), where some nodes serve both backhaul and radio access, is suitable for this kind of backhauling.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example is a camera or video camera loading images or video clips to a network. A user device, or terminal device, may also be a device having capability to operate in Internet of Things (IoT) network which is a scenario in which objects are provided with the ability to transfer data over a network without requiring human-to-human or human-to-computer interaction. The user device may also utilise the cloud. In some applications, a user device may comprise a small portable device with radio parts (such as a watch, earphones or eyeglasses) and the computation is carried out in the cloud. The user device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses. The user device may also be integral part of a larger apparatus, such as a robot or vehicle.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors, and real-time control. 5G supports multiple frequency ranges and is also integrable with existing legacy radio access technologies, such as the LTE. In other words, 5G is planned to support both inter-RAT operability (such as LTE-5G). One of the concepts considered to be used in 5G networks is network slicing in which multiple independent and dedicated virtual sub-networks (network instances) may be created within the same infrastructure to run services that have different requirements on latency, reliability, throughput, and mobility.

The low latency applications and services in 5G require to bring the content close to the radio network users, which is enabled by, for example, multi-access edge computing (MEC). 5G enables analytics and knowledge generation to occur at the source of the data. This approach requires leveraging resources that may not be continuously connected to a network such as laptops, smartphones, tablets, and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet 112, or utilise services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NVF) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes, or hosts. Application of cloudRAN architecture enables RAN real time functions being carried out at the RAN side (in a distributed unit, DU 104) and non-real time functions being carried out in a centralized manner (in a centralized unit, CU 108, 110). Utilization of cloud or edge cloud is also an option (114, 116).

Some other technology advancements probably to be used are Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway/maritime/aeronautical communications. Satellite communication may utilise geostationary earth orbit (GEO) satellite systems, but also low earth orbit (LEO) satellite systems, in particular mega-constellations (systems in which hundreds of (nano)satellites are deployed). Each satellite 106 in the mega-constellation may cover several satellite-enabled network entities that create on-ground cells. The on-ground cells may be created through an on-ground relay node 104 or by a gNB located on-ground or in a satellite.

It is obvious for a person skilled in the art that the depicted system is only an example of a part of a radio access system and in practice, the system may comprise a plurality of (e/g)NodeBs, the user device may have an access to a plurality of radio cells and the system may comprise also other apparatuses, such as physical layer relay nodes or other network elements, etc. At least one of the (e/g)NodeBs or may be a Home(e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells with a range up to hundreds of meters. The (e/g)NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g)NodeBs are required to provide such a network structure.

5G evolution drives the need to study use cases and to propose potential service requirements for 5G system support of Artificial Intelligence (AI)/Machine Learning (ML). Machine learning algorithms build a mathematical model based on sample data, known as training data, in order to make predictions or decisions without being explicitly programmed to carry out the task at issue. In general, machine learning relates to optimization. In many practical applications, the task the algorithm performs is formulated as minimization of a loss function on a training set of examples. A loss function expresses the discrepancy between the predictions of the model being trained and the actual observed incidents (for example, in classification, observed incidents, such as measurement values, are assigned a label or a class, and the ML model is trained to correctly predict the labels for future observed incidents). Many different ML algorithms are known, such as supervised learning, unsupervised learning, and reinforcement learning. In the following, embodiments are further clarified by means of examples using unsupervised learning, however, the embodiments can be applied by using any ML/AI algorithm and not restricted to the examples shown.

Adapting machine learning involves creating a model, which is trained on some training data and used in making predictions. Various types of models exist, such as artificial neural networks, decision trees, support vector machines and regression analysis. Among neural network models, the self-organizing map (SOM) and adaptive resonance theory (ART) are commonly used regarding unsupervised learning algorithms. The SOM is a topographic organization in which nearby locations in the map represent inputs with similar properties. The ART model allows the number of clusters to vary with problem size and lets the user control the degree of similarity between members of the same clusters by means of a user-defined constant called the vigilance parameter. It should be appreciated that embodiments are applicable to any model.

Minimization of Drive Test (MDT) is a standardized 3GPP LTE feature which involves user device (UEs) in automated collection of measurements and reporting them to the network. This concept aims at replacing dedicated and costly drive testing performed for network optimization. MDT involves (regular) users of a cellular network and utilizes data collected anyway (e.g. for mobility purposes). Two MDT reporting approaches are defined: Immediate MDT reporting and Logged MDT reporting. Immediate MDT reporting means that a user device generates real time report of radio measurements after measurements are carried out. In Logged MDT reporting, the user device is configured for measurements when it is in connected mode and the user device collects MDT data when it enters idle or inactive modes. The user device sends reports in a form of logs when it enters connected mode. The user device may indicate measurement availability to the network through a radio resource control (RRC) message and the network may obtain the logged reports through the UEInformationRequest/Response procedure. The two types of MDT, immediate and Logged, provide methods to deliver real-time measurements (e.g. results of measurements performed for typical RRM operations) and non-real time measurements results taken during the time the user device is out of network reach (in RRC IDLE state) respectively.

The ML model may be trained at the user device side or the network side or in both as well as the ML model execution. In case execution of the ML model is at the network side, and depending on the use case that the ML model is addressing, the ML model may need to be executed by the lower layers of the protocol stack, e.g., if the model involves physical layer functions such as pertaining to beam operation or scheduling decisions, or higher layers of the protocol stack, e.g., if the model involves higher layer functions such as pertaining to handover decisions or packet data convergence protocol (PDCP) duplication, to name a few examples. In addition, if an NR gNB retrieves ML model information it may further incorporate ML model retrieval principles to distribute the ML model onwards to other network entities.

A method for distributing an ML model over the network interfaces for functional coordination and for reaching its destination is needed.

In split architectures it is reasonable to expect that not all gNB-DUs under a gNB-CU have ML functionality/capability. It is possible that some advanced gNB-DUs may be capable to perform ML operations, while other legacy gNB-DUs may not support ML. Additionally, it is possible that some gNB-DUs are dedicated to performing more complex ML operations. On the other hand, there may be gNB-DUs, that despite their capability to run ML-based optimization, they may enable or disable the feature depending on the current needs on optimizing a certain network function or behaviour.

A need exists for control operations for distributing ML algorithms for use in split architecture networks where units close to network customers may have different capabilities (such as computational power), functionalities (such as support of lower layer functions e.g., physical layer operations and scheduling, as opposed to midhaul or backhaul units, carrying higher layer functions such as RRC operations). The units carry out different tasks based on service needs and they may be located in different parts of the network either steadily or temporarily (ad hoc networks).

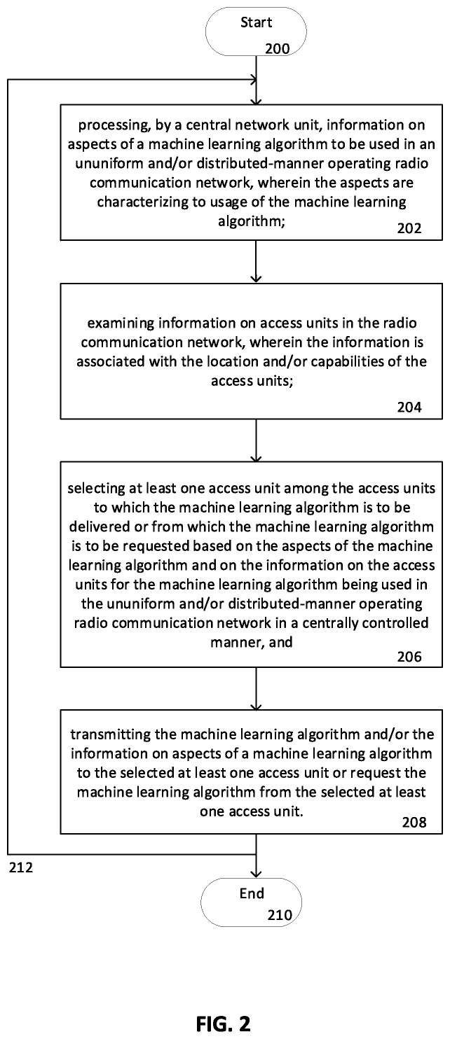

One embodiment starts in block 200 of FIG. 2. This embodiment is suitable for being carried out by a central network unit, such as a CU. A central network unit may be any apparatus that has the computing power and/or data storage capacity needed.

In 5G, for example, when gNB is split into a central unit (gNB-CU) and one or more distributed units (gNB-DUs), the central unit, i.e., a gNB-CU may maintain information regarding ML models that it may retrieve by other network entities or access units (e.g., CUs, DUs, RUs via DUs), user devices (such as UEs) and/or functional entities (such as an operations, administration and management (OAM) entity) as well as actual ML models. The gNB may receive the ML models and ML model related information from a user device (over Uu radio interface), from other gNBs (through Xn interface), from a gNB-DU through F1 interface or from a centralized ML entity (e.g. ML server or OAM) that could be managing the available ML models. Those models may be trained models ready for execution. Alternatively, those models may be untrained models that could be subsequently trained at the entity they are delivered.

The central network unit may store capability (computing power, number of RUs, radio coverage, support for ML) and location information on (other) CUs and/or DUs. The information may also be requested by the central network unit or reported by the DU during the setup process towards the central network unit. The central network unit may also store information on ML algorithms (metadata) in the network (in UEs, DUs, other CUs and on the ones stored by the central network unit itself). Those ML algorithms may be trained or partially trained ML algorithms. Alternatively, those ML algorithms may be algorithms that are being used in execution.

The central network unit may locate the ML algorithm and check based on metadata of the algorithm where it should be delivered. It may further control one or more distributed units and/or cooperate with (other) CUs with regard to the delivery of the algorithm.

In block 202, information on aspects of a machine learning algorithm to be used in an ununiform and/or distributed-manner operating radio communication network is processed, wherein the aspects are characterizing to the usage of the machine learning algorithm.

An ununiform radio communication network may mean a network, where all the access units do not have same capabilities as to, for example, computing power, radio coverage or resources may be enhanced by ad hoc or plug-in apparatuses, or respectively decreased, etc. A distributed-manner operating radio communication network may mean a 5G or future network, where base station operations are divided between centralized and distributed units, where additionally, edge computing or other cloud services may be utilized. The division of tasks may even be service-based (different services may require different computational power, for example).

The information on aspects of the machine learning algorithm may comprise validity time period (namely a period of time when the ML model algorithm is valid), validity area (namely a set of cells, a location area, a routing area, a tracking area, an area defined by a set of coordinates with respect to a latitude and longitude which may also include elevation for example), storage location, information on application layer (namely whether the algorithm is trained and/or executed by lower layer functions such as MAC or PHY or whether it is trained and/or executed by higher layer functions such as RRC or PDCP), needed computing power, needed computing speed, identity information of the machine learning algorithm (such as an index from a catalogue of machine learning models), status of the machine learning algorithm (which may comprise three states training if the algorithm is in training, execution if it is executed during inference or idle in case it is trained but idle waiting to be executed), and/or interest or ability of the access units to use the machine learning algorithm, wherein the information is available as metadata of the machine learning algorithm or with the machine learning algorithm as trained.

The information on aspects of the machine learning algorithm may be stored to be available to the central network unit and/or the information may be requested from the access units either when needed, periodically or as a part of other signalling.

The ML model related information may include metadata comprising (but not limited to):
1) A model descriptor. This may comprise an index from a catalog entry or a model type. From the indexing or model type indication it should be known what the ML model applicability is. For instance, it could be known what is a target (entity) of ML model usage e.g., whether the ML model is meant to capture user device behavior or area/network-based behavior. User device behavior could mean that the ML model optimizes internal user device functions such as its battery consumption, its memory usage, its positioning accuracy, etc. Such models are area-independent and may be valid in a vast number of cells, with different channel propagation and properties, which can even span the whole PLMN, Area-based or network-based behavior could mean that the ML model is used to optimize network functions, such as a Mobility operations, Load Balancing, Network Energy Saving, etc. The validity of such models is strongly dependent on a specific area where the ML model is relevant or valid. This area can be for example an area between two cells, Cell 1 and Cell 2, where a Handover is to be executed or a border between a capacity layer of a gNB and a coverage layer of a gNB where energy saving action is to be taken. A model valid for a Handover between Cell 1 and Cell 2 may not be valid for a Handover between Cell 3 and Cell 4 of the same or of a different gNB. Model descriptor may further include information on a configuration that was used to train the ML model e.g., if training at a user device, CU or DU has been carried out. In one option, the network may trigger the user device to monitor the process of training of a ML model through functions of measurements pre-configured by the network. Therefore, this enhanced MDT configuration could be part of the model descriptor. In addition, ML model descriptor may include information regarding the protocol layers to which the model applies, e.g. PHY/MAC/RLC if the ML model is applicable for the gNB-DU (lower layer functions) for instance if the model is related to optimizing beam operations or optimizing scheduling decisions or RRC and above for the case the ML model is applicable for optimizing gNB-CU (higher layer) operations for instance if the model is related to optimizing mobility operations, energy saving, load balancing or traffic steering decisions.
2) Status. This may comprise three values: training/execution/idle. Status information describes whether an ML model is being trained, whether it is being executed or whether it is idle waiting to be executed. The entity performing these operations may also be included in the metadata (e.g., user device (UE), OAM, etc.).
3) Model performance. This may comprise a choice between training or execution, depending on the planned usage of the ML model.
   a. Training. The performance of an ML model in training may be defined in terms of a maturity condition, namely whether the training has been completed at least to a certain completion threshold (e.g., model is 80% trained) or in terms of duration of the training (e.g., model has been in training for a certain number of hours/days/etc.)
   b. Information on execution. The performance of an ML model in execution may be defined compared to non-ML operation, e.g., ML model performs better than the non-ML Model that has been in use by a certain threshold level.
4) Information on ML idle state may for example provide information on the time that a trained ML model has not been in use (and waits to be activated/executed by the network).
5) Information on the needed computing power may indicate whether the ML model needs to be run on a high-computing machine or not (e.g., this may depend on the number of layers of a neural network used). This descriptor may be categorized into (high, medium, low) to indicate the computing power requirements for the ML model.
6) Validity area. The Validity area of an ML model may be used to determine ML model association with a validity area, where the area is given by a geo-location or network-related identities (network entities, network cells, network beams). The ML model should not be trained or executed outside the defined validity area. The validity area may be updated by defining a new validity area for training the ML model and by carrying out the needed additional training. The validity area may span multiple cells or beams in the case the validity area is defined in terms of a beam e.g., in terms of an SSB beam or a CSI-RS beam. This may be possible in certain areas such as urban areas with high buildings causing strong attenuation to radio signals, especially at high frequencies thus influencing strongly to radio measurements within a gNB or different gNBs. In case of split architectures, those cells may belong to one or more gNB-DUs managed by a single gNB-CU. Alternatively, those cells may belong to one or more gNB-DUs managed by several gNB-CUs.

In addition, the validity area may depend on the ML model and/or the usage of the model, e.g., whether a ML model is modeling user device behavior versus area-based behavior and type of measurements used. The validity area may be defined by OAM or some centralized controller that manages the ML models. The validity area may depend on the property that an ML model characterizes/optimizes, for example: if an ML model is used for area-based behavior, training area may be a cell/set of cells/tracking area etc. (area that ML model is characterizing). An ML model characterizing area-based behavior may for example be an ML model used for load balancing operations, mobility enhancements and positioning optimization. The area-based operation may also be regarding a limited-area network, such as in a factory or shopping center. For example, if the ML model needs to optimize handover operations in terms of e.g. reducing the number of too late handovers, the validity area may be defined to be those cells that observe a high number of radio link failures due to too late handover. In such a case the ML model is trained over only those cells and it will be valid for execution on those cells. Identifying the cells observing a high number of radio link failures due to too late handover may be possible by the managing OAM system which is therefore able to define the validity area of the ML model. As another example, for energy saving use case, if the ML model is to optimize “switching-on” of a capacity cell, the validity area may be defined to be an area comprising “hot-spots” (or otherwise capacity cells) which are switched on on-demand when the ML model determines that coverage needs to be boosted to improve UE performance (e.g., in terms of throughput). Another example for energy saving use case is a scenario applying particular rules for cell switch-off or cell switch-on in a given geographical area (e.g. a university campus) or the cells of that area. In all these cases the ML model involves higher layer operations managed by a gNB-CU. In another exemplifying application, the ML model may be used to optimize lower layer procedures on resource management. As an example, an ML model trained and operated at the gNB-DU to optimize beam operations may have a validity area comprising of all those cells observing a high number of radio link failures (RLF). If the ML model is used to characterize UE behavior, validity area may be a PLMN List or omitted (optional), since ML model validity is area-independent. An ML model characterizing UE behavior may be using ML to optimize internal memory of the user device, display operations, battery consumption, to name a few.
7) Validity time period may indicate the time period that an ML model is valid. This can be given for example by a single timestamp where the time period is defined to end after the timestamp value or it may be given by 2 timestamps with the time period being defined to lie between timestamp 1 and timestamp 2. After the validity time period expires the ML model is not valid anymore. During the validity time period, the ML model may be requested by the access node. After the validity time period expires the ML model may require retraining by the network. Retraining may also comprise training a partially trained ML model. The central network node may also request a training update after the exhaustion of the algorithm validity indicated by a time stamp etc. or at any time: the central network unit may request a training update for the machine learning algorithm for renewing the validity time period or changing the validity area.

In block 204, information on access units in the radio communication network is examined. The information is associated with the location and/or capabilities of the access units.

The access units may comprise distributed units, other central network units and/or user devices.

The capabilities of the access units may comprise computing power, number and/or location of radio units under the control of the access units, mobility, radio coverage and/or support for executing the machine learning algorithm. The capability may also be expressed by the access unit by indicating an interest to receive the model

The examining information on access units may comprise processing information stored to be available to the central network unit and/or requesting the information from the access units.

In block 206, at least one access unit is selected among the access units to which, the machine learning algorithm is to be delivered or from which the machine learning algorithm is to be requested based on the aspects of the machine learning algorithm and on the information on the access units for the machine learning algorithm being used in the ununiform and/or distributed-manner operating radio communication network in a centrally controlled manner. Note that an ML model may be sent to an access unit after being (at least partially) trained according to principles of transfer learning, or it may be sent to the access node for training.

The access units may be (other) CU(s), DU(s) and/or user devices (UE(s)).

For example, after ML model availability is determined by the gNB-CU, it may trigger ML model distribution across network interfaces. If the gNB-CU, that terminates the F1 interface with gNB-DU(s), decides to forward an ML model to one or more gNB-DUs, it may consider ML operations performance capabilities of the distributed network entities under its control. The gNB-CU may forward an ML model to one or more of the gNB-DUs it controls and that have acknowledged enablement of ML operations. The gNB-CU may in addition use the ML model metadata information to determine whether to trigger a retrieval decision of ML models that may be available at other entities in the network (e.g. from a user device). The meta-data information may give information for example about whether the ML model pertains to higher layers of the protocol stack (PDCP, RRC, SDAP) (and is applicable for gNB-CU optimization). In such a case a gNB-CU can determine whether it needs to retrieve such an ML model to optimize its functions.

In this example, if the meta-data information indicates that the ML model pertains to lower layers of the protocol stack (PHY/MAC/RLC) (e.g., if it optimizes lower layer functions related to beam operations) and is therefore applicable for optimization at the gNB-DU, then the gNB-CU may determine to forward the ML model to the gNB-DU. The ML model pertaining to layers applicable to gNB-DU can be directly forwarded from gNB-CU to gNB-DU or first retrieved from a UE and forwarded to the gNB-DU.

The selection of the access units may be based on:
1) Validity area indicated in the metadata: Model is forwarded only to the cells in the validity area.
2) Computing complexity: the ML model is forwarded only to ML capable gNB-DUs that are suitable to execute the model or to perform the specific reinforcement learning operations if the ML model relates to reinforcement learning. For example: a gNB-CU may decide not to upload/receive an ML model of high complexity, if the gNB-DUs it manages are ML capable but have low capability so that they cannot run reinforcement learning or they cannot execute an ML model Also, as an example a gNB-CU will not forward an ML model to a gNB-DU that has switched off its ML capability. Alternatively, a gNB-CU may decide to forward a complex ML model to one or more gNB-DUs, if they have indicated their wish to receive an ML model for a particular problem and have enough processing capability to run a complex model.
3) Access unit's interest to receive the model: the ML model is forwarded only to access units that have indicated they wish to receive an ML model.

In this example, alternatively or in addition, if the ML model pertains to lower layers of the protocol stack and the gNB-CU makes a decision to forward the ML model to a relevant gNB-DU, it may decide to modify a configuration of other gNB-DUs under its control, to perform ML model training or execution. The ML model retrieval may be from the UE, from another gNB (gNB-DU or gNB-CU) or from OAM. The UEs may be machines, such as sensors. Some UEs might have dedicated gNB-DU(s) for which the ML model is relevant, but gNB-CU might decide to configure and involve other gNB-DU(s) in ML model training or execution.

In block 208, transmitting the machine learning algorithm and/or the information on aspects of a machine learning algorithm to the selected at least one access unit or request the machine learning algorithm from the selected at least one access unit.

It is also possible to form a cluster of a part of the access units and carrying out the transmitting of the machine learning algorithm to a head of the cluster or the requesting the machine learning algorithm from the head of the cluster.

The machine learning algorithm may be transmitted for use after training, but is may also be transmitted in other status, for example partly trained for validity area update.

In the example shown in the context of block 206, a gNB-CU may send to its gNB-DU(s) metadata associated with the algorithm (metadata as example of the information on aspects of a machine learning algorithm). By transmitting the metadata, the gNB-CU may advertise the algorithm to its DUs. A receiving gNB-DU may send a response message indicating its interest to receive the algorithm.

A new F1AP procedure, UE associated (when an active UE context is available and an ML model can be associated to this UE) or non-UE associated, (when no active UE context is available) may be introduced for the message exchange, e.g., ML Model Info/ML Model Info Response procedure). In the case a specific user device is associated (UE associated), an ML model may be fine-tuned to optimize ML operations for this specific user device, for example taking into consideration the capabilities and/or location of the user device. It is also an option to request for training update for the specific user device, for example for validity area update based on the mobility and/or location of the user device.

In another option, in case ML model availability is determined by the gNB-DU, it may send an ML model availability indicator to its gNB-CU. This may be sent in a gNB-DU CONFIGURATION UPDATE (or in a newly defined F1AP message). Together with the ML model availability, a gNB-DU may include metadata information in the message.

In the example, an ML model is available at the gNB-DU, the gNB-DU may provide metadata information to the gNB-CU based on which the gNB-CU may decide on whether it wants to retrieve the ML model. The metadata information may be sent from a gNB-DU to a gNB-CU through a GNB-DU CONFIGURATION UPDATE message or through a newly defined F1AP message. Once the gNB-CU determines it wants to retrieve the ML model, it triggers a retrieval procedure with the gNB-DU by transmitting a F1AP message, such as an ML Model Request message for example. The actual ML model is transmitted/received through another F1AP message, such as an F1 ML Model Transfer message.

The new F1AP procedure (e.g., F1 ML Model Transfer) may also be used for sending the actual ML models between a gNB-CU and a gNB-DU. This procedure may be UE-associated (if there is an active UE context on the UE from which the ML model is retrieved) or non-UE associated (in the absence of an active UE context).

A gNB-DU may indicate during the setup of the F1 interface whether it has ML operations enabled or disabled (e.g., it can indicate whether it is ML capable, ML capable with ML operation on, ML capable with ML operation off). If a gNB-DU indicates that its ML operation is enabled, it may further indicate a capability in terms of complexity of an ML model it is able to train or execute (e.g., low, medium, high capability) at any given time. This may depend on the gNB-DU implementation and load conditions.

A gNB-DU may indicate that its ML operations are disabled if it does not support ML due to limited capability. Alternatively, a gNB-DU may indicate that its ML operations are disabled at a given time if there is no need for enhanced optimization, e.g., to support power saving during low load or if network performance is good enough without the use of ML. These could be included as cause values in the reason behind a gNB-DU disables its ML operations e.g., “limited capability”, “performance ok”.

In the case a gNB-DU is ML capable, it may change its indicated ML operability by enabling its ML operations when it determines it needs to enhance or adapt its performance to changes in radio network conditions. The gNB-DU may also indicate that it disables ML operation. A threshold for enabling or disabling the ML operation may be set. The threshold may be based on a ratio with respect to the baseline performance. If threshold conditions are met then this triggers enabling or disabling the ML operation. The threshold may be indicated using F1 SETUP REQUEST or GNB-DU CONFIGURATION UPDATE messages or a newly defined F1AP message sent from a gNB-DU to a gNB-CU.

The embodiment ends in block 210.

The embodiment(s) is repeatable in many ways. One example is shown by arrow 212. It should be understood that the embodiment(s) may be repeated one or more times with a constant or variable pause between separate rounds.

The techniques described herein may be implemented by various means. For example, these techniques may be implemented in hardware (one or more devices), firmware (one or more devices), software (one or more modules), or combinations thereof.

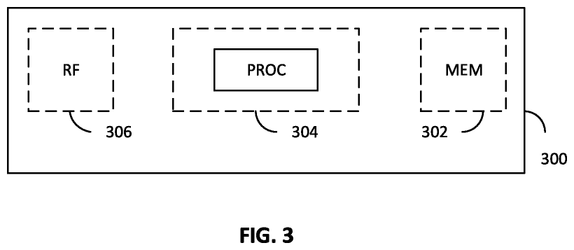

FIG. 3 illustrates a simplified block diagram of an apparatus according to an embodiment in relation to FIG. 2.

An embodiment provides an apparatus which may be a central network unit (such as a CU) or any other suitable apparatus capable to carry out processes described above in relation to FIG. 2. The apparatus may also be implemented using cloud services. It may also be a user device when capable and configured to operate as a central network unit as to the processes described in relation to FIG. 2.

It should be appreciated that the apparatus may include or otherwise be in communication with a control unit, one or more processors or other entities capable of carrying out operations according to the embodiments described by means of FIG. 2. It should be understood, that each block of the flowchart of FIG. 2 and any combination thereof may be implemented by various means or their combinations, such as hardware, software, firmware, one or more processors and/or (electronic) circuitry.

Terms “receive”, “transmit” and “broadcast” may comprise reception or transmission via a radio path. These terms may also mean preparation of a message to the radio path for an actual transmission or processing a message received from the radio path, for example, or controlling or causing a transmission or reception, when embodiments are implemented by software.

As an example of an apparatus according to an embodiment, it is shown apparatus 300, including facilities in control unit or circuit/circuitry 304 (including one or more processors, for example) to carry out functions of embodiments according to FIG. 2. The facilities may be software, hardware or combinations thereof as described in further detail below.

In FIG. 3, block 306 includes parts/units/modules needed for reception and transmission, usually called a radio front end, RF-parts, radio parts, remote radio head, etc. The parts/units/modules needed for reception and transmission may be comprised in the apparatus or they may be located outside the apparatus the apparatus being operationally coupled to them. The apparatus may also include or be coupled to one or more internal or external memory units.

Another example of apparatus 300 may include at least one processor 304 and at least one memory 302 including a computer program code, the at least one memory and the computer program code configured to, with the at least one processor, cause the apparatus at least to: process, by a central network unit, information on aspects of a machine learning algorithm to be used in an ununiform and/or distributed-manner operating radio communication network, wherein the aspects are characterizing to usage of the machine learning algorithm, examine information on access units in the radio communication network, wherein the information is associated with the location and/or capabilities of the access units, select at least one access unit among the access units to which the machine learning algorithm is to be delivered or from which the machine learning algorithm is to be requested based on the aspects of the machine learning algorithm and on the information on the access units for the machine learning algorithm being used in the ununiform and/or distributed-manner operating radio communication network in a centrally controlled manner, and transmit the machine learning algorithm and/or the information on aspects of a machine learning algorithm to the selected at least one access unit or request the machine learning algorithm from the selected at least one access unit.

It should be understood that the apparatus may include or be coupled to other units or modules etc., such as radio parts or radio heads, used in or for transmission and/or reception. This is depicted in FIG. 3 as optional block 306.

Yet another example of an apparatus comprises means (302, 304) for processing, by a central network unit, information on aspects of a machine learning algorithm to be used in an ununiform and/or distributed-manner operating radio communication network, wherein the aspects are characterizing to usage of the machine learning algorithm, means (302, 304) for examining information on access units in the radio communication network, wherein the information is associated with the location and/or capabilities of the access units, means (302, 304) for selecting at least one access unit among the access units to which, the machine learning algorithm is to be delivered or from which the machine learning algorithm is to be requested based on the aspects of the machine learning algorithm and on the information on the access units for the machine learning algorithm being used in the ununiform and/or distributed-manner operating radio communication network in a centrally controlled manner, and means (302, 304, 306) for transmitting the machine learning algorithm and/or the information on aspects of a machine learning algorithm to the selected at least one access unit or request the machine learning algorithm from the selected at least one access unit.

It should be understood that the apparatus may include or be coupled to other units or modules etc., such as radio parts or radio heads, used in or for transmission and/or reception. This is depicted in FIG. 3 as optional block 306. The apparatus may also include or be coupled to a communications or user interface.

Although the apparatuses have been depicted as one entity in FIG. 3, different modules and memory may be implemented in one or more physical or logical entities.

An apparatus may in general include at least one processor, controller, unit, module or (electronic) circuitry designed for carrying out functions of embodiments operationally coupled to at least one memory unit (or service) and to typically various interfaces. A circuitry may refer to hardware-only circuit implementations, such as implementations in only analog and/or digital circuitry, combinations of circuits and software (and/or firmware), such as different kind of processors of portions of them, software and/or circuit components, such as a microprocessor(s) or a portion of a microprocessor(s). Further, the memory units may include volatile and/or non-volatile memory. The memory unit may store computer program code and/or operating systems, information, data, content or the like for the processor to perform operations according to embodiments described above in relation to FIG. 2. Each of the memory units may be a random-access memory (RAM), dynamic RAM, static RAM (SRAM), a flash memory, a solid-state disk (SSD), PROM (programmable read-only memory), a suitable semiconductor, or any other means of implementing an electrical computer memory. The memory units may be at least partly removable and/or detachably operationally coupled to the apparatus. The memory may be of any type suitable for the current technical environment and it may be implemented using any suitable data storage technology, such as semiconductor-based technology, flash memory, magnetic and/or optical memory devices. The memory may be fixed or removable.

The apparatus may be an (electronic) circuit or a system of (electronic) circuits performing a particular function in an electronic device with a computer program code. The (electronic) circuit may comprise at least one processor and additionally at least one internal or external memory.

As used in this application, the term ‘circuitry’ (or circuit) refers to all of the following: (a) hardware-only circuit implementations, such as implementations in only analog and/or digital circuitry, and (b) combinations of circuits and soft-ware (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

The apparatus may be, include or be associated with at least one software application, module, unit or entity configured as arithmetic operation, or as a program (including an added or updated software routine), executed by at least one operation processor. Programs, also called program products or computer programs, including software routines, applets and macros, may be stored in any apparatus-readable data storage medium and they include program instructions to perform particular tasks. The data storage medium may be a non-transitory medium. The computer program or computer program product may also be downloaded to the apparatus. A computer program product may comprise one or more computer-executable components which, when the program is run, for example by one or more processors possibly also utilizing an internal or external memory, are configured to carry out any of the embodiments or combinations thereof described above by means of FIG. 2. The one or more computer-executable components may be at least one software code or portions thereof. Computer programs may be coded by a (high level) programming language or a low-level programming language.

Embodiments provide computer programs embodied on a distribution medium, comprising program instructions which, when loaded into electronic apparatuses, constitute the apparatuses as explained above or causes the apparatus to carry out embodiments described above in relation to FIG. 2. The distribution medium may comprise, for example: any entity or device capable of carrying the computer program code to the one or more processors, a record medium, a computer memory, a read-only memory, an electrical carrier signal, a telecommunications signal, and a software distribution medium. In some jurisdictions, depending on the legislation and the patent practice, the computer-readable medium or a distribution medium may not be the telecommunications signal. In an embodiment, the computer-readable medium or a distribution medium may be a computer-readable storage medium. In an embodiment, the computer-readable medium or the distribution medium may be a non-transitory computer-readable storage medium.

Embodiments provide computer programs comprising instructions which, when the program is executed by an apparatus, cause the apparatus to carry out embodiments described by means of FIG. 2.

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

There are many ways to structure the computer program code: the operations may be divided into modules, sub-routines, methods, classes, objects, applets, macros, etc., depending on the software design methodology and the programming language used. In modern programming environments, there are software libraries, i.e. compilations of ready-made functions, which may be utilized by the computer program code for performing a wide variety of standard operations. In addition, an operating system (such as a general-purpose operating system) may provide the computer program code with system services.

Modifications and configurations required for implementing functionality of an embodiment may be performed as routines, which may be implemented as added or updated software routines, application circuits (ASIC) and/or programmable circuits. Further, software routines may be downloaded into an apparatus. The apparatus, such as a node device, or a corresponding component, may be configured as a computer or a microprocessor, such as single-chip computer element, or as a chipset, including at least a memory for providing storage capacity used for arithmetic operation and an operation processor for executing the arithmetic operation.

A non-exhaustive list of implementation techniques for the processor and the memory includes, but is not limited to: logic components, standard integrated circuits, application-specific integrated circuits (ASIC), system-on-a-chip (SoC), application-specific standard products (ASSP), microprocessors, microcontrollers, digital signal processors, special-purpose computer chips, field-programmable gate arrays (FPGA), and other suitable electronics structures.

For firmware or software, the implementation may be carried out through modules of at least one chip set (e.g., procedures, functions, and so on) that perform the functions described herein. The software codes may be stored in a memory unit and executed by processors. The memory unit may be implemented within the processor or externally to the processor. In the latter case it may be communicatively coupled to the processor via various means, as is known in the art. Additionally, the components of systems described herein may be rearranged and/or complimented by additional components in order to facilitate achieving the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The invention and its embodiments are not limited to the examples described above but may vary within the scope of the claims.

1-16. (canceled)

17. An apparatus comprising:
at least one processor and at least one memory including a computer program code, the at least one memory and the computer program code configured to, with the at least one processor, cause the apparatus at least to:
process, by a central network unit, information on aspects of a machine learning algorithm to be used in an ununiform and/or distributed-manner operating radio communication network, wherein the aspects are characterizing to usage of the machine learning algorithm;
examine information on access units in the radio communication network, wherein the information is associated with the location and/or capabilities of the access units;
select at least one access unit among the access units to which the machine learning algorithm is to be delivered or from which the machine learning algorithm is to be requested based on the aspects of the machine learning algorithm and on the information on the access units for the machine learning algorithm being used in the ununiform and/or distributed-manner operating radio communication network in a centrally controlled manner, and
transmit the machine learning algorithm and/or the information on aspects of a machine learning algorithm to the selected at least one access unit or request the machine learning algorithm from the selected at least one access unit.

18. The apparatus of claim 17, wherein the information on aspects of the machine learning algorithm comprise validity time, validity area, storage location, information on application layer, needed computing power, needed computing speed, identity information of the machine learning algorithm, status of the machine learning algorithm, and/or interest or ability of the access units to use the machine learning algorithm, wherein the information is available as metadata of the machine learning algorithm or with the machine learning algorithm as trained.

19. The apparatus of claim 17, wherein the access units comprise distributed units, other central network units and/or user devices.

20. The apparatus according any to claim 17, further comprising causing the apparatus to request training update for the machine learning algorithm for renewing the validity time or changing the validity area.

21. The apparatus according to claim 17, wherein the capabilities of the access units comprise computing power, number and/or location of radio units under the control of the access units, mobility, radio coverage, and/or support for executing the machine learning algorithm and/or interest for receiving the machine learning algorithm.

22. The apparatus of claim 17, further comprising causing the apparatus to form a cluster of a part of the access units and carrying out the transmitting the machine learning algorithm to a head of the cluster or the requesting the machine learning algorithm from the head of the cluster.

23. The apparatus of claim 17, wherein the processing of the information on the aspects of the machine learning algorithm and/or the examining information on access units comprises processing information stored to be available to the central network unit and/or requesting the information from the access units.

24. A method comprising:
processing, by a central network unit, information on aspects of a machine learning algorithm to be used in an ununiform and/or distributed-manner operating radio communication network, wherein the aspects are characterizing to usage of the machine learning algorithm;
examining information on access units in the radio communication network, wherein the information is associated with the location and/or capabilities of the access units;
selecting at least one access unit among the access units to which the machine learning algorithm is to be delivered or from which the machine learning algorithm is to be requested based on the aspects of the machine learning algorithm and on the information on the access units for the machine learning algorithm being used in the ununiform and/or distributed-manner operating radio communication network in a centrally controlled manner, and
transmitting the machine learning algorithm and/or the information on aspects of a machine learning algorithm to the selected at least one access unit or request the machine learning algorithm from the selected at least one access unit.

25. The method of claim 24, wherein the information on aspects of the machine learning algorithm comprise validity time, validity area, storage location, information on application layer, needed computing power, needed computing speed, identity information of the machine learning algorithm, status of the machine learning algorithm, and/or interest or ability of the access units to use the machine learning algorithm, wherein the information is available as metadata of the machine learning algorithm or with the machine learning algorithm as trained.

26. The method of claim 24, wherein the access units comprise distributed units, other central network units and/or user devices.

27. The method according to claim 24, further comprising requesting training update for the machine learning algorithm for renewing the validity time or changing the validity area.

28. The method according to claim 24, wherein the capabilities of the access units comprise computing power, number and/or location of radio units under the control of the access units, mobility, radio coverage, and/or support for executing the machine learning algorithm and/or interest for receiving the machine learning algorithm.

29. The method of claim 24, further comprising forming a cluster of a part of the access units and carrying out the transmitting the machine learning algorithm to a head of the cluster or the requesting the machine learning algorithm from the head of the cluster.

30. The method of claim 24, wherein the processing of the information on the aspects of the machine learning algorithm and/or the examining information on access units comprises processing information stored to be available to the central network unit and/or requesting the information from the access units.
